(19) United States
(12) Patent Application Publication
(10) Pub. No.: US 2018/0285414 A1
(43) Pub. Date: Oct. 4, 2018

(54) DATABASE MANAGEMENT SYSTEM CLUSTER NODE SUBTASKING DATA QUERY

(71) Applicant: OCIENT, INC, Chicago, IL (US)

(72) Inventors: George Kondiles, Chicago, IL (US); Rhett Colin Starr, Long Grove, IL (US)

(21) Appl. No.: 15/942,976

(22) Filed: Apr. 2, 2018

Related U.S. Application Data
(60) Provisional application No. 62/480,601, filed on Apr. 3, 2017.

(51) Int. Cl. G06F 17/30; G06F 9/48; G06F 9/52

(52) U.S. Cl. CPC G06F 17/30445; G06F 17/30463; G06F 9/52; G06F 9/4881

(57) ABSTRACT

A cluster node within a cluster of a highly parallel database system includes at least one processing unit that runs a set of first tier threads and a set of second tier threads, a storage disk drive, and a networking interface. When a first tier thread receives a task, it divides the task into a set of subtasks. The first tier thread also assigns the set of subtasks between a subset of the set of second tier threads for execution. Each second tier thread within the subset processes the one or more subtasks it is assigned to. When the task is a work, the subtasks are work units. When the task is a work unit, the subtasks are subwork units.

### CROSS REFERENCE TO RELATED APPLICATIONS

This application claims the benefit and priority of U.S. Patent Application No. 62/480,601 entitled “DATABASE MANAGEMENT SYSTEM USING HYBRID INDEXING LIST AND HIERARCHICAL QUERY PROCESSING ARCHITECTURE,” filed Apr. 3, 2017, which is hereby incorporated by reference in its entirety. This application is related to U.S. Patent Application No. 62/403,328, entitled “APPLICATION DIRECT ACCESS TO NETWORK RDMA MEMORY,” filed on Oct. 3, 2016, assigned to Ocient, INC, which is hereby incorporated by reference in its entirety. This application is also related to U.S. Patent Application No. 62/403,231, entitled “HIGHLY PARALLEL DATABASE MANAGEMENT SYSTEM,” filed on Oct. 3, 2016, assigned to Ocient, INC, which is hereby incorporated by reference in its entirety. This application is related to U.S. Patent Application No. 62/433,901, entitled “EFFICIENT DATABASE MANAGEMENT SYSTEMS,” filed on Dec. 14, 2016, assigned to Ocient, INC, which is hereby incorporated its entirety. This application is also related to U.S. Patent Application No. 62/433,919, entitled “USE OF A DESIGNATED LEADER TO MANAGE A CLUSTER OF NODES IN A DATABASE MANAGEMENT SYSTEM,” filed on Dec. 14, 2016, assigned to Ocient, INC, which is hereby incorporated by reference in its entirety.

### FIELD OF THE DISCLOSURE

The present invention generally relates to a system and method for organizing and managing large volume of data, and more particularly relates to a massively parallel database management system optimized for managing time based data. More particularly still, the present disclosure relates to hybrid indexing structures, manifests and three tiered hierarchical data query processing architectures used in silos within a massively parallel database management system.

### DESCRIPTION OF BACKGROUND

With rapid development and widespread utilization of computer technologies in the last few decades, large volumes of digital data are generated on a daily basis. Organizing and managing such a huge amount of data has promoted the development of database technologies. Relational database management systems (“RDBMS”), such as Oracle Database Management System, Microsoft SQL Database Management System and MySQL Database Management System, have thus been proposed and gained broad acceptance for data management. Such database management systems store data by rows of tables. Querying and retrieving data from conventional databases oftentimes include retrieving a list of records while such records contain information that is not requested. For example, the illustrative SQL query causes a conventional database management system to read fifty rows from a disk drive storing the rows:

select column1 from table1 where key >100 and key <151

In the illustrative SQL query, column1 is a column of a table 1, and key is another column (such as a primary key) of the table 1. While only data in column1 is requested, data in other columns of table1 is already read from a storage disk drive. Furthermore, the conventional database management systems do not store data in an ordered manner on physical disk drives. However, many types of data (such as network logs, network access data, financial transaction data, weather data, etc.) are of extremely high volume and ordered by time. Accordingly, there is a need for a highly parallel and efficient database system that is optimized for managing large volumes of time based data. There is a further need for a highly parallel and efficient database system for storing data by columns for faster and more efficient data retrieval.

Conventional database management systems typically generate a large number of indexes for data. Such indexes logically identify rows (also referred to herein as records). Rows of data within a table are stored on disk drives. Related rows, such as rows of a particular order by time, are typically stored consecutively in large groups on disk drives in order to improve the efficiency of read operations on those rows. Rows could also be related by other factors. Retrieving a set of related records thus involves reading entire sets of such rows at once in large sequential read operations. If the rows to be retrieved are not related to one another in the same manner in which they were stored, reading them involves multiple disk reads of data dispersed at different locations on a disk drive, which has typically been an inefficient operation. Accordingly, there is a need for a highly parallel and efficient database system for storing rows in smaller clusters on disk with the intention of reading them all in parallel, and providing an efficient structure for locating such data on a disk drive. There is a further need for a new database management system to load the structure in memory for higher performance in locating data on disk drives.

To improve data retrieval performance, conventional database management systems take advantage of high end hardware platforms, such as a computer with multiple sockets and a large amount of memory. Each of the sockets includes one or more processing units (also interchangeably referred to herein as cores). A processing unit housed in one socket can access resources (such as disk drives and memory) local to another socket. Such cross socket access incurs a performance penalty due to latency and bandwidth limitations of the cross-socket interconnect. Accordingly, there is a need for a highly parallel and efficient database management system that improves performance by avoiding the cross socket boundary access. The present disclosure incorporates novel solutions to overcome the above mentioned shortcomings of conventional database management systems.

Storage drive access is typically the performance bottleneck in conventional database management systems due to the fact that storage drives are not fully utilized. In a conventional database management system, disk drives are in idle state during various time periods. One major reason for the underutilization of the storage drives is that the conventional database management systems are not efficient in processing data queries and data fetched from storage drives. For example, conventional database management systems lack a high level of parallelism in processing queries and data returned from storage drives. Accordingly, there is a need for a massively parallel database management that maximizes storage drive utilization and minimizes wait on the drives. In particular, there is a need for a massively parallel database management that utilizes silo systems and hybrid indexing tables in memory, tiered query and data parallel processing and manifests within silo systems.

### Objects of the Disclosed System, Method, and Apparatus

Accordingly, it is an object of this disclosure to provide a parallel database management system optimized for managing large volumes of time based data.

Another object of this disclosure is to provide a parallel database management system with silo systems that utilize only local resources for faster performance.

Another object of this disclosure is to provide a parallel database management system with silo systems that utilize only local resources to avoid latency and bandwidth limitations inherent in interconnect access.

Another object of this disclosure is to provide a parallel database management system with silo systems that utilize only local memory and local disk drives for faster performance.

Another object of this disclosure is to provide a parallel database management system with a signal rich manifest describing physical locations of data stored on a disk drive for locating the maximum amount of data while taking the least amount of memory and disk space.

Another object of this disclosure is to provide a parallel database management system with a hierarchical manifest describing physical locations of data stored on a disk drive for faster data retrieval from a storage disk by direct reads.

Another object of this disclosure is to provide a parallel database management system with a manifest for each segment.

Another object of this disclosure is to provide a parallel database management system with a manifest stored in each segment.

Another object of this disclosure is to provide a parallel database management system with a manifest stored at end of each segment.

Another object of this disclosure is to provide a parallel database management system with a hierarchical manifest in a physically backed memory region for faster access minimizing page faults.

Another object of this disclosure is to provide a parallel database management system with a hierarchical manifest organizing data by cluster keys.

Another object of this disclosure is to provide a parallel database management system with a hierarchical manifest organizing data by time based data buckets for each cluster key.

Another object of this disclosure is to provide a parallel database management system with a hierarchical manifest organizing data by time based data buckets of equal time frames.

Another object of this disclosure is to provide a parallel database management system with time based data stored on disk drives based on the order of time stamps of the data.

Another object of this disclosure is to provide a parallel database management system with time based data of different time periods stored in different segment groups.

Another object of this disclosure is to provide a parallel database management system with data records stored by columns for faster performance in retrieving data from physical disk drives.

Another object of this disclosure is to provide a parallel database management system with data records stored by columns for reducing reads of physical disk drives in data retrieval.

Another object of this disclosure is to provide a parallel database management system with data records stored by columns in coding blocks of different coding lines on a segment to allow fewer reads in data retrieval.

Another object of this disclosure is to provide a parallel database management system to store data records by columns in a segment with a manifest indicating the location of the data on the physical disk drive of the segment for faster data retrieval.

Another object of this disclosure is to provide a parallel database management system to store a data record along with a confidence about the accuracy of the data record.

Another object of this disclosure is to provide a parallel database management system that prioritizes analytical calculations on large datasets.

Another object of this disclosure is to provide a parallel database management system that prioritizes analytical calculations on large datasets based on characteristics of the analytical calculations and characteristics of the dataset.

Another object of this disclosure is to provide a parallel database management system that prioritizes an analytical calculation based the rank of a similar analytical calculation based on characteristics of the two analytical calculations.

Another object of this disclosure is to provide an in-memory sorted hybrid indexing list with both header entries and data entries containing entry counts and cluster keys respectively.

Another object of this disclosure is to provide an in-memory sorted hybrid indexing list with data entries containing cluster keys linking to a manifest respectively.

Another object of this disclosure is to provide a three tiered hierarchical data query processing architecture in a silo within a massively parallel database system.

Another object of this disclosure is to provide a three tiered hierarchical data query processing architecture with a dispatcher thread, a set of search threads and a set of aggregation threads pinned to a silo within a massively parallel database system.

Another object of this disclosure is to provide a three tiered hierarchical data query processing architecture with a dispatcher thread, a set of search threads, a set of aggregation threads, and a storage drive access thread pinned to silo within a massively parallel database system.

Another object of this disclosure is to provide a three tiered hierarchical data query processing architecture within a silo that divides a work into multiple work units processed by a set of search threads within a massively parallel database system.

Another object of this disclosure is to provide a three tiered hierarchical data query processing architecture within a silo that divides a work into multiple work units processed by a set of search threads, and each work units into multiple subwork units assigned to a set of aggregation threads within a massively parallel database system.

Another object of this disclosure is to provide a three tiered hierarchical data query processing architecture with a dispatcher thread, a set of search threads causing data read requests processed by a storage drive access thread, and a set of aggregation threads processing data fetched from a storage drive by the storage drive access thread.

Another object of this disclosure is to provide a three tiered hierarchical data query processing architecture with a lower tier communicating backward pressure to an upper tier and the upper tier then balancing load on the lower tier.

Another object of this disclosure is to provide a three tiered hierarchical data query processing architecture with a search thread communicating backward pressure to a dispatcher thread and the dispatcher thread then balancing load distributed to the search thread.

Another object of this disclosure is to provide a three tiered hierarchical data query processing architecture with a search thread determining its load status based utilization of its buffers.

Another object of this disclosure is to provide a three tiered hierarchical data query processing architecture with an aggregation thread communicating backward pressure to a search thread and the search thread then balancing load distributed to the aggregation thread.

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

Generally speaking, pursuant to the various embodiments, the present disclosure provides a massively parallel database management system for managing massive volumes of data. In particular, massively parallel database management system is optimized for managing time based data. A database management software application running in user space directly accesses a disk drive to store and retrieve data for faster performance. The time based data is stored in coding blocks of segments of a segment group of a cluster. Coding blocks of different segments within the same segment group are grouped in coding lines. The cluster includes a set of nodes, each of which includes one or more storage disk drives. Each disk drive includes one or more segments.

Each node includes one or more sockets while each socket houses a set (meaning one or more) of processing units. A socket and its processing units are operatively coupled to a set of local resources, such as a local memory, a local disk drive and a local network interface card. A processing unit accesses the local devices at a higher speed than accesses to remote devices that are local to a different socket. The two sockets are interconnected by an interconnect interface. The cross socket access is slower due to latency and bandwidth limitation in the interconnect interface. A socket, the process units housed in the socket, and physical devices local to the socket are termed herein as a silo. The massively parallel database management system implementing the silo oriented computing achieves faster performance due to the fact that the data management processing within different silos uses only local devices. Data management threads are pinned to specific processing units with a silo such that the threads only access local memory and other local resources.

For improved performance in data retrieval reads and data storing writes, the novel data management system accesses disk drives directly without going through middle layers, such as a file system of an operating system. The data management system software application maintains a manifest to track the exact physical location where a particular piece of data is stored in a segment of a physical disk drive. The manifest embodies a compact structure such that it minimizes storage overhead for relational information in a segment while occupying a small footprint. The manifest is thus optimized to occupy less memory and disk drive space while providing the maximum amount of signal. The manifest is stored, for example, at the end of each segment while data is stored in coding blocks from the beginning of the segment.

Since data requests usually demand data in certain columns, but not all columns of data records, the database management system software application further improves on conventional technologies by storing data by columns in coding blocks on segments within a cluster. By retrieving only data of one or multiple columns, the number of reads is reduced because the amount of data read is less that the total amount of data within all of the relevant records. To further speed up data queries, different segment groups store time based data of different time periods. In such a case, a requested data record is first quickly narrowed to a segment group based on the time stamp of the data record.

The manifest indicates the location of data stored in the corresponding segment. The manifest organizes data records by cluster keys. For each cluster key, data is organized as data buckets of sequential, but not necessarily contiguous, time periods. The different time periods are of the same time duration (also referred to herein as time frame) in one implementation. For each data bucket, data is stored by columns, wherein each stored column is indicated by coding lines and storage byte offsets.

Further in accordance with various embodiments, the present teachings provide a database management system that stores data records along with confidence data. The confidence data indicates a confidence in the accuracy of a data record or data point. In addition, analytical calculations for analyzing large datasets are prioritized for effective data analysis. The prioritization can be based on characteristics of the analytical calculations and/or characteristics of a particular dataset. Furthermore, a rank of one analytical calculation is assigned to a similar analytical calculation. The ranks are determined based on, for example, execution results of the analytical calculations on the dataset.

Further in accordance with various embodiments, the present teachings provide a cluster system with a query coordinator dispatching a data query to each node within the cluster system of a massively parallel database management system. The distribution of the query to each node within the cluster allows highly parallel processing of the query by multiple nodes.

Further in accordance with various embodiments, the present teachings provide an in-memory hybrid indexing table for fast data search. The hybrid indexing table is sorted for fast search. Furthermore, the hybrid indexing table includes both header entries and data entries. Each data entry includes attributes (such as IP addresses) of a data query and a cluster key. The cluster key is present in a manifest associating the cluster key to specific locations on a storage drive storing the data corresponding to the data query. The hybrid indexing table allows the database management system to quickly identify the physical location of the requested data of a query in a storage drive.

Further in accordance with various embodiments, the present teachings provide a tiered hierarchical data query and retrieved data processing system within a silo. A three tiered hierarchical architecture includes a dispatcher thread in the first tier, a set of search threads in the second tier and a set of aggregation threads in the third tier. Furthermore, the three tiered hierarchical architecture includes a storage drive access thread for accessing one or more storage drives. The dispatcher thread breaks a work (such as a query) into a batch of work units and assigns the work units to a set of search threads. Each search thread breaks its work units into a batch of subwork units, and generates a data read request for the storage drive read thread to fetch the corresponding data from one of the storage drives. The data read request indicates the physical location of the data in the storage drive. When the data is read from the drive, one of the associated aggregation threads then processes the data. Thereafter, the search thread merges data corresponding to the subwork units. The dispatcher thread then merges data for the work units, and returns the merged data.

Each search thread determines its task load status, which indicates the backward pressure on the search thread. The search thread communicates the backward pressure to the dispatcher thread. In response, the dispatcher thread balances the load on the search threads. Similarly, the backward pressure handling mechanism is also applicable between aggregation threads and search threads. The backward pressure handling mechanism avoids hot spots in the three tiered hierarchical paradigm. Furthermore, the highly parallel query and data processing by the dispatcher thread, the search threads and the aggregation threads provides the maximum amount of data read requests to the storage drive read thread within any particular time period. Accordingly, the three tiered hierarchical paradigm causes the storage drive read thread and the storage drive to be in a highly utilized state. With the storage drive and the storage drive thread utilization maximized, the latency of data being made available for processing is minimized. In other words, the wait on the storage drive to return all requested data is minimized.

Further in accordance with the present teachings is a cluster node within a database management system. The cluster node includes a processing unit, a storage disk drive accessible by the processing unit, and a networking interface operatively coupled to the processing unit. The cluster node also includes a set of first tier threads running on the processing unit, and a set of second tier threads running on the processing unit. The first tier thread within the set of first tier threads is adapted to receive a task for retrieving data stored on the storage disk drive, divide the task into a set of subtasks; and assign the set of subtasks between a subset of second tier threads within the set of second tier threads.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a simplified block diagram of a node within a cluster of a highly parallel database management system in accordance with this disclosure.

FIG. 2A is a flow chart illustrating a process by which a node within a cluster of a highly parallel database management system implements silo oriented resource accesses in accordance with this disclosure.

FIG. 2B is a flow chart illustrating a process by which a node within a cluster of a highly parallel database management system implements silo oriented resource accesses in accordance with this disclosure.

FIG. 2C is a flow chart illustrating a process by which a node within a cluster of a highly parallel database management system implements silo oriented resource accesses in accordance with this disclosure.

FIG. 3 is a simplified block diagram depicting a segment with a manifest in accordance with this disclosure.

FIG. 4 is a table illustrating time stamp based data in accordance with this disclosure.

FIG. 5 is a simplified block diagram illustrating the layout of records stored in a segment in accordance with this disclosure.

FIG. 6 is a simplified block diagram illustrating a storage cluster of time based data in accordance with this disclosure.

FIG. 7 is a simplified block diagram illustrating a logical representation of a manifest in accordance with this disclosure.

FIG. 8 is a simplified block diagram illustrating the memory structure of a manifest 700 in accordance with the teachings of this disclosure.

FIG. 9 is a data record without 100% confidence of accuracy in accordance with the teachings of this disclosure.

FIG. 10A is a flowchart depicting a process by which a computer prioritizes analytical calculations in accordance with the teachings of this disclosure.

FIG. 10B is a flowchart depicting a process by which a computer prioritizes analytical calculations in accordance with the teachings of this disclosure.

FIG. 11 is a simplified block diagram of a cluster of nodes of a massively parallel database management system in accordance with the teachings of this disclosure.

FIG. 12 is a high speed in-memory hybrid indexing table in a silo in a massively parallel database management system in accordance with the teachings of this disclosure.

FIG. 13 is a flowchart depicting data retrieval using hybrid indexing lists in a silo in a massively parallel database management system in accordance with the teachings of this disclosure.

FIG. 14 is a simplified block diagram depicting a three layer hierarchical data query processing architecture in a silo in a massively parallel database management system in accordance with the teachings of this disclosure.

FIG. 15 is a simplified block diagram depicting a three layer hierarchical data query processing architecture with a work divided into smaller tasks in a silo in a massively parallel database management system in accordance with the teachings of this disclosure.

FIG. 16 is a flowchart depicting a process by which a search thread processes a work unit in accordance with the teachings of this disclosure.

FIG. 17 is a block diagram of a buffer list maintained by a search thread in accordance with the teachings of this disclosure.

FIG. 18 is a flowchart depicting a process by which a storage drive reading thread handles data read requests in accordance with the teachings of this disclosure.

FIG. 19 is a flowchart depicting a process by which an aggregation thread processes data read by a drive access thread in accordance with the teachings of this disclosure.

FIG. 20 is a flowchart depicting a process by which a search thread handles data from aggregation threads in accordance with the teachings of this disclosure.

FIG. 21 is a simplified block diagram depicting a three layer hierarchical data query processing architecture in accordance with the teachings of this disclosure.

FIG. 22 is a flowchart depicting a process by which a search thread provides backward pressure to an upper tier in accordance with the teachings of this disclosure.

FIG. 23 is a flowchart depicting a process by which an upper tier allocates tasks based on backward pressure in accordance with the teachings of this disclosure.

FIG. 24 is a simplified block diagram depicting a three layer hierarchical data query processing architecture in accordance with the teachings of this disclosure.

FIG. 25 is a flowchart depicting a process by which slios within a node process a work and combine data read by the silos in accordance with the teachings of this disclosure.

A person of ordinary skills in the art will appreciate that elements of the figures above are illustrated for simplicity and clarity, and are not necessarily drawn to scale. The dimensions of some elements in the figures may have been exaggerated relative to other elements to help understanding of the present teachings. Furthermore, a particular order in which certain elements, parts, components, modules, steps, actions, events and/or processes are described or illustrated may not be actually required. A person of ordinary skill in the art will appreciate that, for the purpose of simplicity and clarity of illustration, some commonly known and well-understood elements that are useful and/or necessary in a commercially feasible embodiment may not be depicted in order to provide a clear view of various embodiments in accordance with the present teachings.

### DETAILED DESCRIPTION

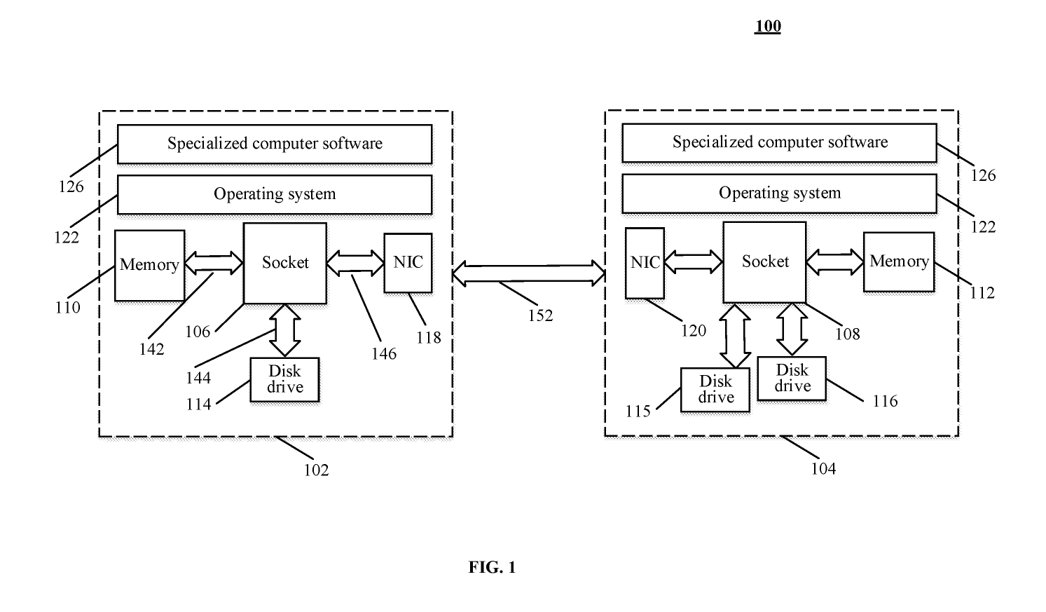

Turning to the Figures and to FIG. 1 in particular, a simplified block diagram of a node within a cluster of a highly parallel database management system is shown and generally indicated at 100. The database storage node 100 includes two sockets 106 and 108, each of which includes one or more processing units (also interchangeably referred to herein as cores and central processing units). The node 100 also includes a memory (such as 32 GB of DRAM) 110, a storage disk drive 114, and a networking interface (“NIC”) 118 that are operatively coupled to the socket 106. An operating system (such as Linux operating system) 122 runs on the processing units of the socket 106. The operating system 122, the memory 110, the socket 106, the NIC 118 and the disk drive 114 are collectively referred to herein as a silo 102. The silo system 102 includes all processing units within the socket 106 and all the disk drives (such as the disk drive 114) operatively coupled to the socket 106. The node 100 further includes a memory 112, two storage disk drives 115 and 116, and a NIC 120 that are operatively coupled to the socket 108. The operating system 122, the memory 112, the storage disk drives 115-116, and the NIC 120 are collectively referred to herein as a silo 104.

A specialized computer software 126 for managing data runs on the operating system 122 within the silos 102 and 104 respectively. In one implementation, the operating system 122 is a single instance running on the sockets 106-108 of the node 100. In one implementation, the specialized computer software 126 programs each silo to perform a part of a task. The specialized computer software 126 can also program one silo (such as the silo 102) to perform one task, and another silo (such as the silo 104) to perform a different task.

The disk drives 114-116 are storage devices for storing data, and can be, for example, Non-volatile Random-Access Memory (“NVRAM”), Serial Advanced Technology Attachment (“SATA”) Solid State Drives (“SSDs”), or Non-volatile Memory Express (“NVMe”). As used herein, drives, storage drives, disk drives and storage disk drives are interchangeably used to refer to any types of data storage devices, such as NVRAM, SATA, SATA SSDs and NVMe. Each of the disk drives (such as the drives 114-116) has one or more segments. For ease of illustration, each of the disk drives 114-116 is said to include only one segment and interchangeably referred to as a segment herein. Segments within a cluster form a segment group.

The processing units within the socket 106 directly access the memory 110, the NIC 118 and the disk drive 114 over electrical interfaces, such as Peripheral Component Interconnect Express (“PCIe”). For example, the socket 106 directly accesses these physical devices via a PCIe bus, a memory control, etc. Similarly, the socket 108 directly access the memory 112, the NIC 120 and the disk drives 115-116.

In contrast, the processing unit(s) within the socket 108 accesses the memory 110, the disk drive 114 and the NIC 118 via an interconnection interface 152. Similarly, the processing unit(s) within the socket 106 accesses the NIC 120, the disk drives 115-116 and the memory 112 via the same interconnection interface 152. The access over the interconnect interface 152 between the sockets 106 and 108 is referred to herein as an indirection connection. In other words, a socket within each silo directly accesses physical devices within the same silo, and indirectly accesses physical devices within a different silo. Physical devices within one silo are said to be local to the silo and remote to a different silo.

In one implementation, the interface 152 is a QuickPath Interconnect (“QPI”) interface or an UltraPath Interconnect (“UPI”) interface. The indirect access between the silos 102-104 incurs a performance penalty due to latency inherent in indirect access. Furthermore, the interconnect interface 152 becomes a bottleneck in indirect access. In addition, the interconnect interface 152 has a bandwidth limitation. Accordingly, accessing remote devices over the interconnect interface 152 is less desirable. To overcome the performance issues imposed by the indirect access, the present teachings provide the specialized database management system software 126 to implement a silo oriented database system.

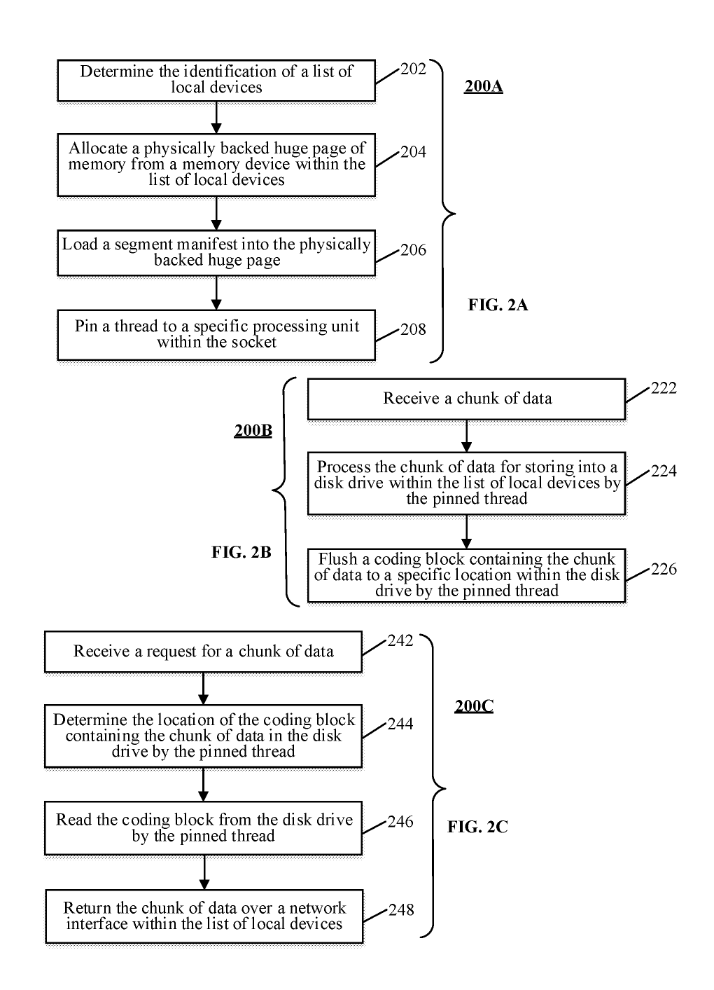

In the silo based data management system, the instance of the specialized database management system software 126, running on the processing unit(s) within the socket 106, accesses only the local resources, such as the memory 110, the NIC 118 and the disk drive 114 that are local to the socket 106 and all the processing units within the socket 106. Similarly, the instance of the software 126 running on the processing unit(s) within the socket 108 accesses only the NIC 120, the memory 112 and the disk drives 115-116 local to the socket 108 and all the processing units within the socket 108. In other words, the instance of the software 126 running on the socket 108 do not access the remotely connected physical devices 110, 114, 118 when, for example, data queries are served. However, cross-silo access is possible in certain cases, such as system startup and shutdown. It should be noted that the silo boundary based computing is programmed for a set of predetermined functionality. For example, for storing data into and retrieving data from a database and disk drives, the specialized program 126 limits its access to local devices and avoids remote access to a different silo. The silo boundary control is further illustrated by reference to FIGS. 2A, 2B and 2C.

Referring to FIGS. 2A, 2B and 2C, three flow charts illustrating processes by which the node 100 implements the silo oriented highly efficient database management are shown and generally indicated at 200A, 200B and 200C respectively. The processes 200A-200C are performed by the specialized database management program 126. The process 200A is initiated when the program 126 is loaded and run by the processing units within a socket of a silo, such as the socket 106 of the silo system 102. In one implementation, the software program 126 runs as a process in the silo 102. The process includes one or more threads. The threads within the process share the same virtual address space and can all access the same physical resources (such as memory and other physical devices). At 202, the specialized database management software 126 determines the identification of a list of local devices, such as the processing units within the socket 106, the memory 110, the disk drive 114 and the NIC 118. For instance, the software 126 queries the operating system 122 for identification and other information of the list of local devices. Each physical device within the list can be identified by, for example, a name or a handle.

At 204, the special software program 126 performs a specialized memory allocation to allocate a huge page of the memory 110. The huge page is a big swatch of memory (such as 1 GB) that is a virtual memory region. The huge page is physically backed by the memory 110. In other words, the virtual memory region corresponds to a region of the same size on the memory device 110. Multiple accesses to the virtual memory region result in the same physical region being accessed. A processor maintains a cache of virtual-to-physical page mappings (i.e., the Translation Lookaside Buffer (“TLB”)); and by utilizing a huge page the special software is able to address larger regions of memory with fewer TLB cache entries. The physically backed huge page is also referred to herein as a physical huge page of memory. The physically backed huge page is within the silo boundary, and corresponds to a segment manifest.

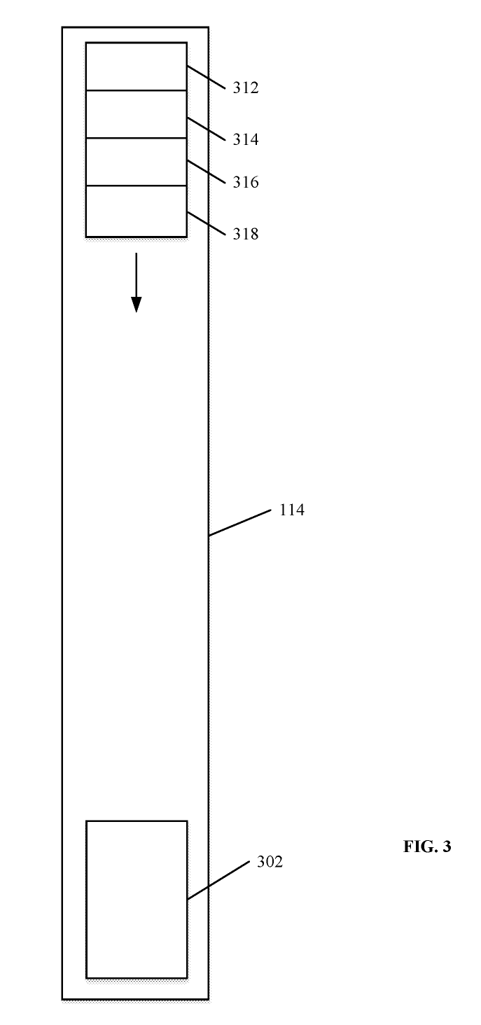

At 206, the specialized software program 126 loads a segment manifest into the physically backed huge page. The manifest describes a hierarchical structure indicating the location of data in the segment (such as the disk drive 114). In one implementation, each segment stores a manifest. A segment with a manifest is further illustrated by reference to FIG. 3.

Turning to FIG. 3, a simplified block diagram depicting a segment 114 with a manifest 302 is shown. In the segment 114, data is stored in coding blocks, such as the coding blocks 312-318. Coding blocks are written into the segment 114 in a sequential order starting from the beginning of the segment 114. In one implementation, the manifest 302 of the segment 114 is stored at the end of the segment 114. In one embodiment, the manifest 302 occupies a fixed size of the disk space on the segment 114. As further described below, the manifest 302 contains the maximum amount of signal for a certain size of storage. The signal is data indicating information about other data, such as the physical location of a block of data within a storage drive.

Returning to FIG. 2A, the manifest resides in memory for the best performance in locating data stored in the local disk drive 114. At 208, the specialized database software 126 pins a thread within the process of the software 126 to one or more processing units (such as CPUs and cores) within the socket 106 via operating systems calls. For example, the calls include “pthread_setaffinity_np” and/or “sched_setaffinity” on a Linux operating system. Operations (such as searches) on the loaded manifest that are performed by the pinned thread are then only performed on the memory 110 within the silo 102, not the memory 112 that is remote to the silo 102.

Referring to FIG. 2B, at 222, the specialized database management software 126 receives a chunk of data for storing into the disk drive 114 via the NIC 118. The chunk of data is some amount of data, such as a set of time based data records of the same or different cluster keys. At 224, the pinned thread processes the chunk of data for storing it onto the disk drive 114. For example, the pinned thread places the chunk of data into an open coding block, and updates the manifest to reflect the exact location where the chunk of data is stored in the segment 114. When the open coding block is full, at 226, the pinned thread directly flushes the coding block into the segment 114. It should be noted that the updated manifest is also flushed to the segment 114 periodically or when certain events occur.

Referring to FIG. 2C, at 242, the specialized database management software 126 receives a request for a chunk of data, such as a set of columns of certain records. At 244, the pinned thread searches the manifest in the physically backed huge page to determine the location of the coding blocks containing the requested data in the segment 114. At 246, the pinned thread reads the coding blocks from the segment 114. At 248, the pinned thread returns the request chunk of data over the NIC 118. It should be noted that the processes 200B-200C directly accesses the disk drive 114 using its identification determined by the process 200A. Furthermore, the process 200C directly accesses the NIC 118 using its identification determined by the process 200A. Accordingly, the operations to store a chunk of data are performed within a single silo; and the operations for retrieving and returning a chunk of data are also performed within a single silo. The silo oriented database management thus provides superior performance and efficiency.

Many types of data are generated in great volumes and of similar or same formats. For example, a computer network logger produces large volumes of records of the same format. Another example of the time based data is weather data. Each record includes a time stamp (meaning the time when the record is generated), a cluster key, and a number columns of other types of data. The cluster key can identify, for instance in network log data, a source IP address and a destination IP address. The source IP address is the IP address of the computer or device sending the data contained in the record, while the destination IP address is the IP address of the computer or device receiving the data contained in the record. In one implementation, the cluster key is derived from the source IP address (also referred to herein as local IP address) and the destination IP address (also referred to herein as remote IP address). Alternatively, the cluster key is derived from the local IP address, the remote IP address and a remote IP port number associated with the remote IP address. The remote IP address and the remote port collectively identify the remote computer receiving the data.

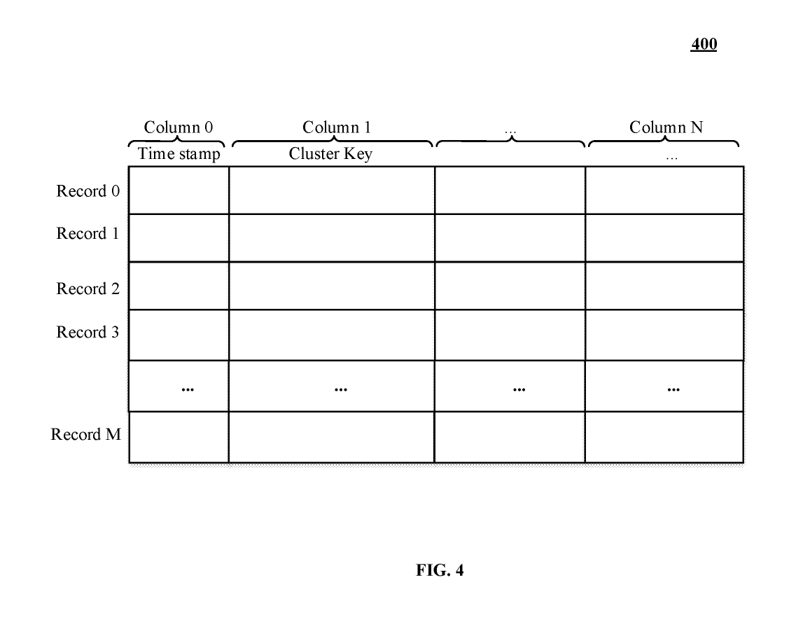

Such time stamp based data is uploaded to a database management system to be stored in disk drives, such as the disk drives 114-116. A logical representation of the time based data is further illustrated by reference to FIG. 4. Referring to FIG. 4, a table illustrating time stamp based data is shown and generally indicated at 400. The data is represented as a list of records 0-M (M stands for a positive integer). Each record has a time stamp in column 0, such as Oct. 12, 2016, 19:03:01, CST. The time stamp may further include additional information, such as milliseconds. A time stamp can also be represented by an integer, instead of a text string. Column 1 of the table 400 contains the cluster key of each record. Columns 2 through N (N stands for a positive integer) contain other data of each record.

The records with the same cluster key are said to be related. Taking a network logger as an example, the cluster key is the pair of source IP address and the destination IP address. All records with the same cluster key are data sent from a particular computer or device to another particular computer or device, and are said to be related herein. The related records have different time stamps and are also ordered by the time stamps. For instance, records 0-500 have a same cluster key while records 501-1000 share a different cluster key.

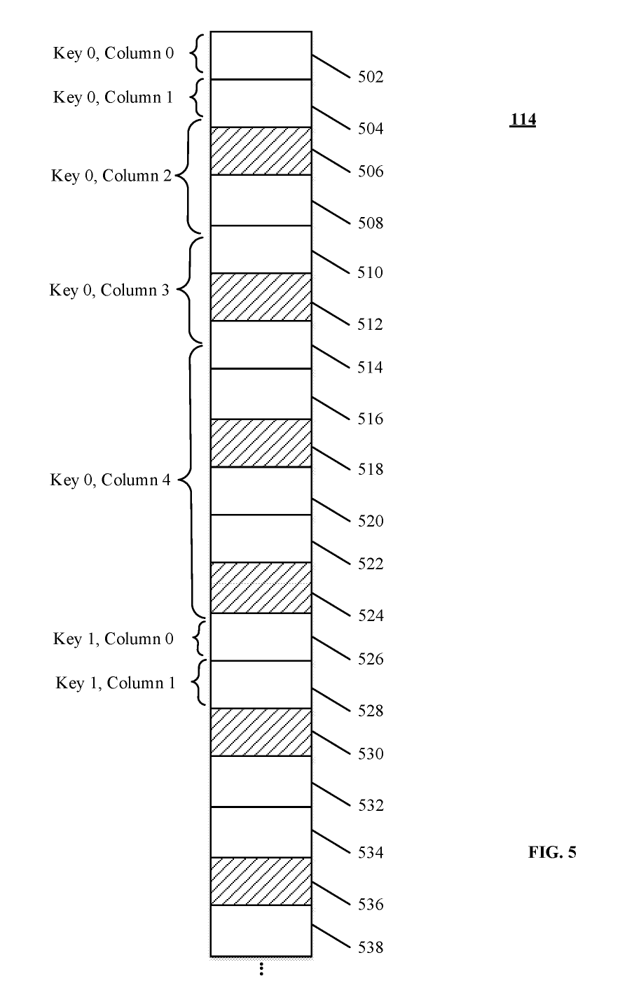

To maximize the performance in serving requests for such data after it is stored on the disk drives 114-116, the present database management system stores the records 0-M based on columns, instead of rows. Data queries usually request one or more columns of certain records, such as records during a particular time period. Storing the records 0-M by columns allows the minimum amount of reads to retrieve the desired data from a disk drive. The column based data storage in the highly parallel database management system is further illustrated by reference to FIG. 5.

Referring to FIG. 5, a simplified block diagram illustrating the layout of records stored in the segment 114 is shown. A set of representative coding blocks of data are indicated at 502 through 538 with the coding blocks 506,512,518,524,530,536 being the parity blocks storing parity information for the corresponding coding lines. Each coding block of the coding blocks 502-538 is associated with a coding line that encompasses all segments within a segment group.

For example, data of Column 0 of the records with cluster key 0 (meaning a first cluster key) during a particular time period is stored in coding block 502; data of column 1 of the records with cluster key 0 during the particular time period is stored in coding blocks 502-504; data of column 2 of the records with cluster key 0 during the particular time period is stored in coding blocks 504, 508-510; data of column 3 of the records with cluster key 0 during the particular time period is stored in coding blocks 510 and 514; data of column 4 of the records with cluster key 0 during the particular time period is stored in coding blocks 514-516,520-522,526; data of column 0 of the records with cluster key 1 during the particular time period is stored in coding block 526; data of column 1 of the records with cluster key 1 during the particular time period is stored in coding blocks 526-528; etc. Records of the cluster key 0 (as well as the cluster key 1) during the particular time period are ordered by their corresponding time stamps from, for example, the oldest to the newest.

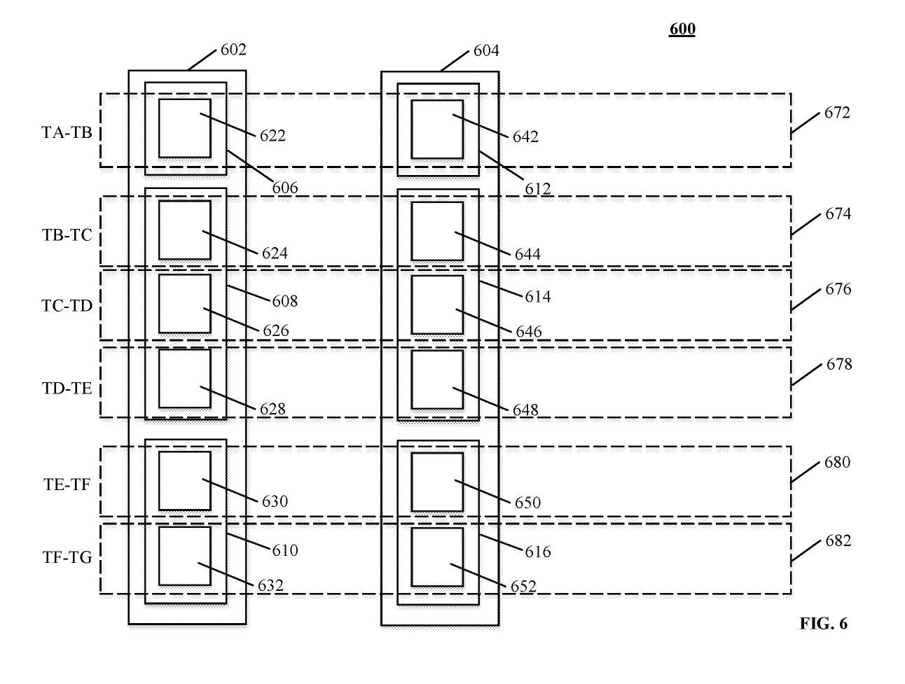

The time based data is sequentially stored in segments groups, each of which comprises a set of segments. A particular time period is mapped to a small fixed set of segment groups. For example, in one implementation, a particular time period is mapped to a unique segment group. As an additional example, a particular time period is mapped to two segment groups in a different implementation due to the fact that segment groups can overlap slightly in time at their boundaries. The mapping is further illustrated by reference to FIG. 6. Turning to FIG. 6, a simplified block diagram illustrating a storage cluster of time based data is shown and generally indicated at 600. The cluster 600 includes a set of nodes, of which two are indicated at 602 and 604. The node 602 includes data storage disk drives 606 (such as the drive 114), 608 and 610 while the node 604 includes disk drives 612, 614 and 616. The drive 606 includes a segment 622; the drive 608 includes three segments 624, 626 and 628; the drive 610 includes two segments 630 and 632; the drive 612 includes a segment 642; the drive 614 includes three segments 644, 646 and 648; and the drive 616 includes two segments 650 and 652. The illustrative cluster 600 includes segment groups 672, 674, 676, 678, 680 and 682. The segment group 672 includes the segments 622, 642 and other segments (not shown). As another example, the segment group 680 includes the segments 630 and 650.

The time based data between time TA and time TB is stored in the segment group 672; the time based data between time TB and time TC is stored in the segment group 674; the time based data between time TC and time TD is stored in the segment group 676; and so on. The time stamps TA, TB, TC, TD, TE, TF and TG are ordered from the oldest to the latest. Accordingly, when a data record is requested, the segment group storing the record is first determined based on the time stamp of the record. The time based storage of data in the cluster 600 thus provides an efficient and faster response to a data query. The lengths of different time periods, such as from TA to TB and from TB to TC, may differ.

When time based data records are received, a segment group and a segment within the segment group is first determined for storing the record. For example, a function is performed on the cluster key of the records to determine the segment group and the segment. The function is shown below:

function(cluster key)=segment group identifier and segment identifier

The data records are then forwarded to the node (such as the node 100) having the segment. The data records are then received by the target node. For example, the data record is received at 222 of the process 200B. The function (cluster key) enables even distribution data records between segments within a segment group.

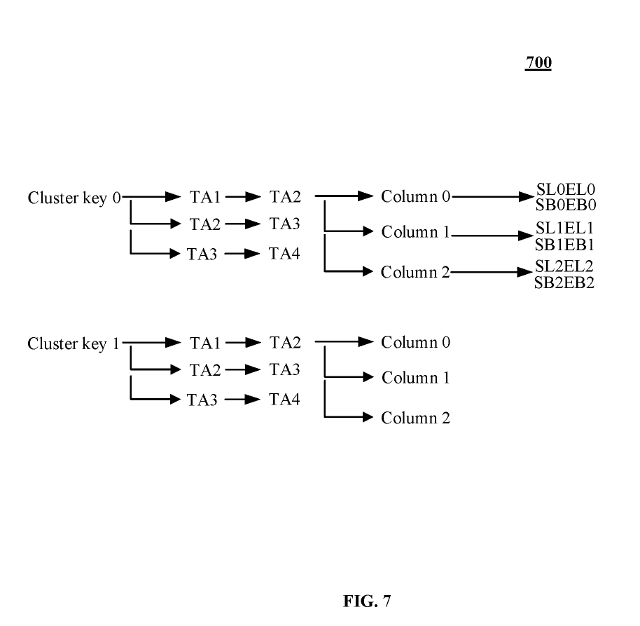

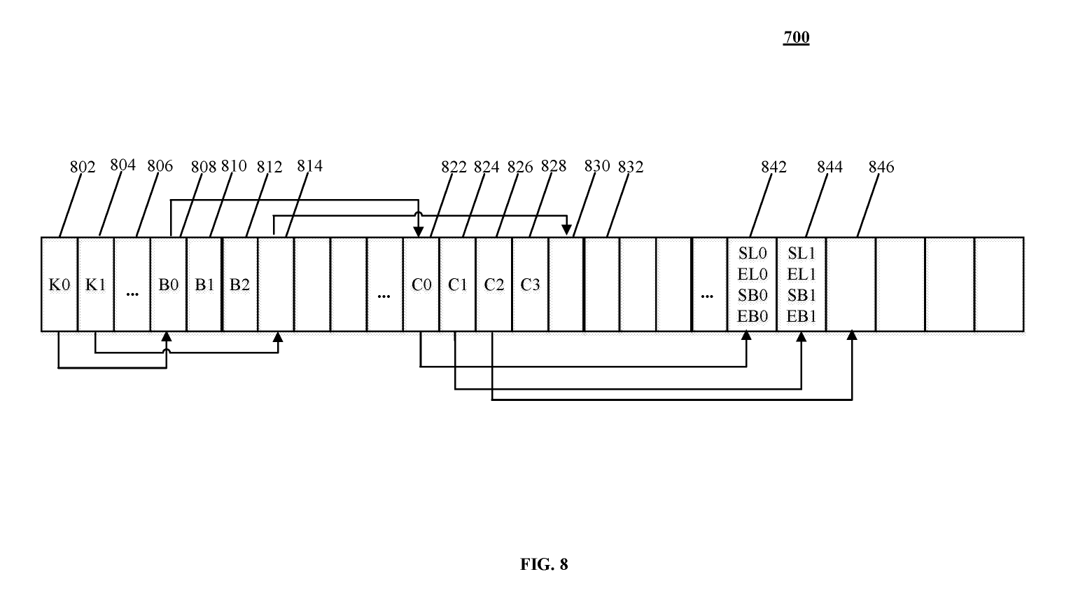

For efficiently placing and searching the time based data records, a hierarchical manifest for each segment is created and managed by the specialized database management software 126. The manifest is further illustrated by reference to FIGS. 7 and 8. Turning first to FIG. 7, a logical representation of a manifest is shown and generally indicated at 700. Time based data is grouped by cluster keys (such as the cluster key 0 and the cluster key 1); and time based data of each cluster key is grouped into buckets based on time. For example, a first data bucket of the cluster key 0 includes data from time stamp TA1 to time stamp TA2; a second data bucket includes data from time stamp TA2 to time stamp TA3; and a third data bucket includes data from time stamp TA3 to time stamp TA4. In one implementation, the time period for each data bucket is the same. In other words, TA2−TA1=TA3−TA2=TA4−TA3.

Within each data bucket, data records are organized by columns starting from column 0 to column 1 to column 2, and so on. Taking the cluster key 0 as an example, the data in the column 0 within the bucket of the period from TA1 to TA2 is stored in one or more coding blocks. The coding blocks are identified by a starting coding block number SL0, and an ending coding block number EL0. The coding block numbers SL0 and EL0 are also referred to herein as a starting coding block line and an ending coding block line. Accordingly, SL0 and EL0 identify one or more consecutive blocks on the segment storing the corresponding data. SB0 indicates the starting byte location from the beginning of the first coding block of the one or more consecutive coding blocks, while EB0 indicates the ending byte location from the beginning of the first coding block of the one or more consecutive blocks. In other words, the storage space starting from the byte at SB0 to the byte at EB0 in the one or more consecutive coding blocks store the data of the column 0 of the time based records in the data bucket between TA1 and TA2 of the cluster key 0. A data bucket cannot be empty. If no data is present for a particular time period, no bucket is stored, and during retrieval the lack of a bucket is interpreted as there being no data for that time period. In one embodiment, the manifest is immutable; and, if changes are required, the entire manifest is regenerated.

Referring to FIG. 8, a simplified block diagram illustrating the memory structure of the manifest 700 is shown. Cluster keys are stored in memory slots 802, 804 and 806 (indicating multiple memory slots). Each of these slot further stores a location, such as offset from the beginning of the manifest 700, of the corresponding buckets for the associated cluster key. Taking cluster key 0 in the memory slot 802 as an example, the data bucket location information is pointed to by the location and stored in the memory slots 808, 810 and 812. Taking the first data bucket as an example, it is indicated in the memory slot 808, which contains the time stamps of the bucket and a location pointing to the column information of the bucket. The location points to the memory slot 822, which stores information (such as data type) of the column 0 and a location pointing to the memory slot 842. The memory slot 842 stores the starting coding line number (SL0), the ending coding line number (EL0), the starting byte offset (SB0) and the ending byte offset EB0. There could be more than one memory slot (such as the memory slot 842) corresponding to a particular column when the span of data for a key/column pair interests with one or more parity blocks. The compact structure of the manifest 700 contains the maximum amount of signal about stored data while using the least amount of memory.

In one embodiment, the time based data is compressed before it is stored into a segment of the node 100. For instance, the data of column 3 of a particular data bucket of a particular cluster key is encoded. The compression can be optionally performed on some columns. For example, the compression is not performed on the time stamp and cluster key columns. The compression form can be, for example, Run-Length Encoding (“RLE”). In one implementation, the compression is performed at 224 of the process 200B.

Certain types of data, such as genomic base pairs in a genome sequence, are created in such a manner that the data value is not known to be 100% accurate. In other words, there is not a 100% confidence in the accuracy of such data. For instance, a gene sequencer may estimate that a genomic base pair at a given location is 90% likely to be C-G and 10% likely to be A-T. As an additional example, when network traffic data is collected, the accuracy of each data record may be affected by the bit error rate of the network hardware or some other reasons. When mathematical and statistical analysis is later performed on such data without 100% confidence in its accuracy, the confidence of the calculated output data would be affected by the less than 100% confidence in the network traffic data. Accordingly, in one embodiment, the confidence information about the data is stored in the database. When the data records are retrieved from the database system storing such records, the corresponding data confidence is also retrieved. The data confidence is further incorporated and considered in the analysis of the data records.

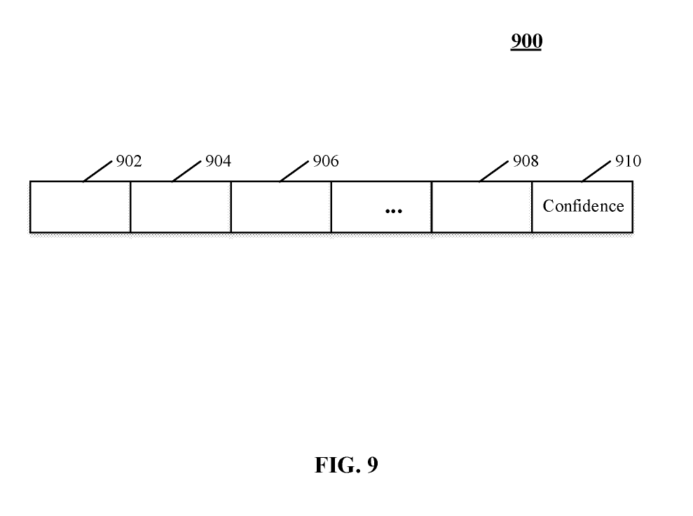

The data without 100% confidence in accuracy and the confidence information are further illustrated by reference to FIG. 9. Referring to FIG. 9, a data record without 100% confidence in its accuracy is shown and generally indicated at 900. The data record 900 includes columns 902 through 908. The confidence information is stored in one or more additional columns, such as the column 910. The data record 900 is first constructed in memory of a database management system computer and then stored in, for example, the segment 114.

Various datasets, such as network traffic data, financial transactions, and digital sensor data, are growing rapidly each day and becoming so large that humans can no longer examine such data and get a sense of what is unusual with such datasets. Accordingly, computers are needed to analyze these large datasets to determine whether any data abnormality are present. Computers generally analyze a dataset by performing analyses, such as calculating a standard deviation or a distance between data points. As used herein an analysis is also referred to as a calculation. On a large dataset, only a limited number of calculations could be effectively performed. Accordingly, prioritizing calculations to perform on large datasets is more desirable.

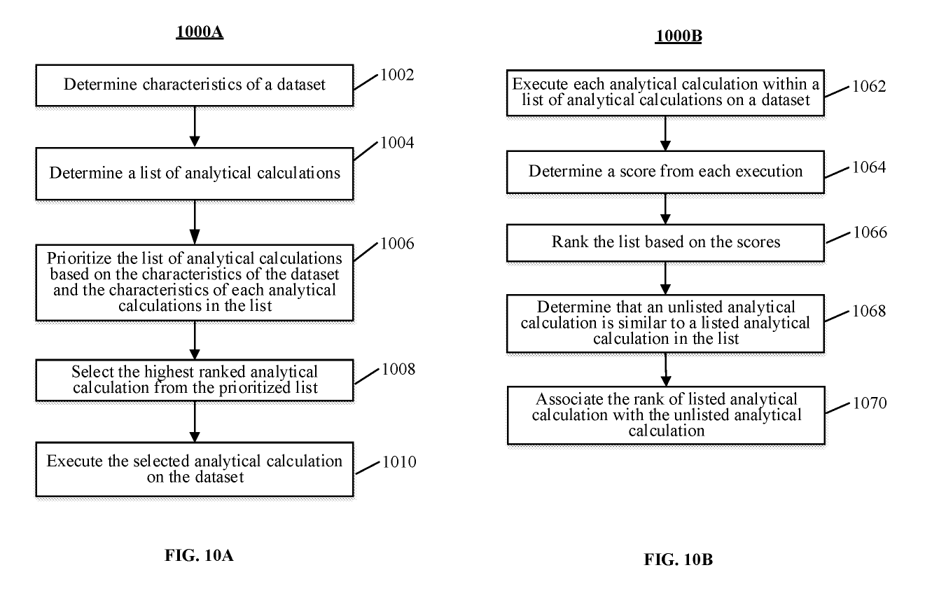

For example, it is beneficial to prioritize those next calculations of data abnormality in a dataset by prioritizing the calculations likely to complete faster. In a different implementation, future analytical calculations are prioritized based on how the results of previous calculations are scored. An analytical calculation similar to a previously executed calculation with high scoring results is also prioritized higher. In other words, the analytical calculation is assigned with the same priority score. The analytical calculation prioritization is further illustrated by reference to FIGS. 10A and 10 B.

Referring to FIGS. 10A and 10B, two flowcharts depicting two processes by which a computer (such as the node 100) prioritizes analytical calculations are shown and generally indicated at 1000A and 1000B respectively. At 1002, a specialized software application running on the computer determines characteristics of a dataset. The characteristics include, for example, the number of records in the dataset and data types of columns of the records. At 1004, the software application determines a list of analytical calculations that may be executed on the dataset for determining any abnormality (such as errors, distorted data, data noise, etc.) in the dataset. At 1006, the software application prioritizes the list of analytical calculations based on the characteristics of a dataset and the characteristics of each analytical calculation in the list. For example, whether a calculation processes a dataset by performing only linear operations (such as comparisons) is a characteristic of the analytical calculation. As an additional example, whether a calculation processes a dataset by performing square root operations is a characteristic of the analytical calculation. Some characteristics deem the execution of a calculation on a dataset to be slower while others are faster. The prioritization associates a rank with each analytical calculation. At 1008, the software application selects the highest ranked analytical calculation from the prioritized list of analytical calculations. At 1010, the software application executes the selected analytical calculation on the dataset.

Referring now to FIG. 10B, at 1062, the software application executes each analytical calculation within a list of analytical calculations on a particular dataset. The list of analytical calculations includes one or more calculations. At 1064, the software application determines a result score of the execution of each analytical calculation on the dataset. At 1066, the software application ranks the list based on the scores. At 1068, the software application determines than an unlisted analytical calculation (meaning an analytical calculation that is not in the list) is similar to a listed analytical calculation (meaning a particular analytical calculation within the list). For example, the similarity is based on similar characteristics of the two analytical calculations. At 1070, the software application associates the rank of the listed analytical calculation with the unlisted analytical calculation.

The present disclosure teaches a massively parallel database management system optimized for managing time based data. The database system provides significant performance improvement over conventional database management system. For example, the massively parallel database management system is capable of processing tens and even hundreds of millions of data queries per second. To achieve the unprecedented performance, the database management system incorporates various novel features, such as high speed hybrid indexing tables in memory for fast search, a three tiered hierarchical dynamic query and data processing system, and others as set forth herein.

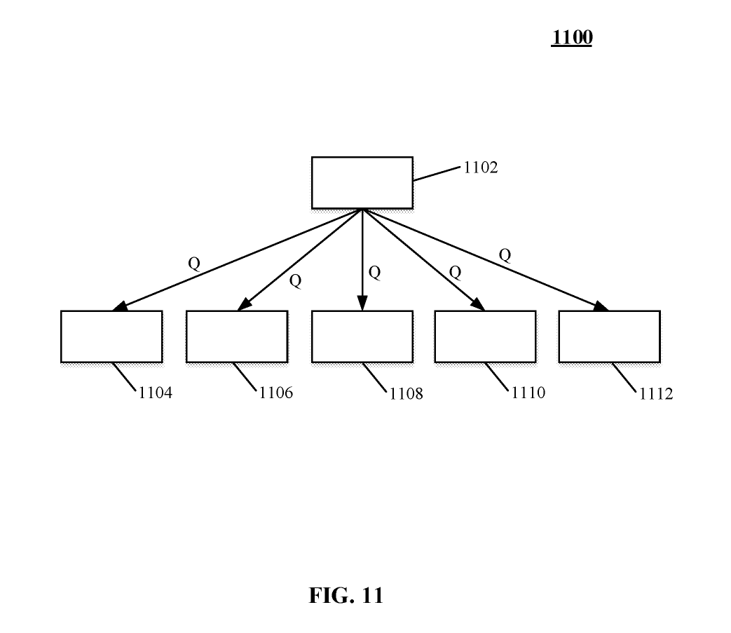

Referring to FIG. 11, a simplified block diagram of a cluster of nodes within the massively parallel database management system is shown and generally indicated at 1100. The cluster 1100 includes a set of nodes, such as nodes 1104, 1106, 1108, 1110 and 1112. The cluster 1100 also includes a query coordinator 1102. In one implementation, the query coordinator 1102 is a node within the set of nodes 1104-1112. In such a case, the particular node acts as a query coordinator for a period of time or on a per query basis. Alternatively, the query coordinator 1102 is a dedicated computer within or outside of the cluster 1100. When a query (“Q”) for data is received by the cluster 1100, the cluster 1100 processes the query and returns the requested data. For example, the query is a data query for time based data between timestamp T1 and T2 sent from local IP address IP1 to remote IP address RIP1 and remote IP port RP1. The query coordinator 1102 forwards the query to each node within the cluster 1100. In response, each node (including the node 1102) within the cluster 1100 processes the same query, and returns data that it stores and meets the requirements of the query.

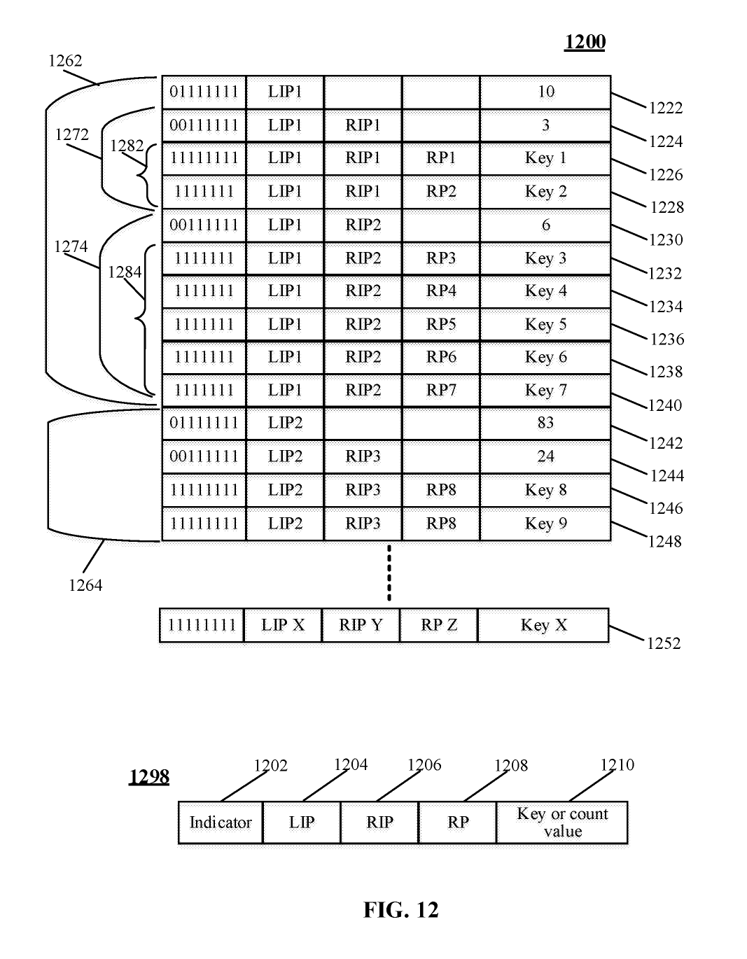

Each node within the cluster 1100 maintains one or more fast hybrid indexing table structures in memory for high speed data query processing. One high speed hybrid indexing table is illustrated in FIG. 12 and generally indicated at 1200. Referring to FIG. 12, the hybrid indexing table 1200 is a list of entries 1298. The entry 1298 includes an indicator 1202, a local IP address (“LIP”) 1204, a remote IP address (“RIP”) 1206, a remote IP port (“RP”) 1208, a value field 1210. The entry 1298 is a header entry when it indicates a collection of other header entries and data entries. In such a case, the value field 1210 is the count of entries within the collection plus the header entry itself. When the entry 1298 is a data entry, it indicates a cluster key in the value field 1210.

The illustrative hybrid indexing table 1200 includes entries 1222 through 1252. The collection of entries with LIP1 in the LIP field 1204 is indicated at 1262 while the list of entries with LIP2 in the LIP field 1204 is indicated at 1264. The entry 1222 in the list 1262 is the first entry with the first bit of the indicator 1202 set to 0 and other bits set to 1. The 0 value indicates that the entry 1222 is a header entry and starts with a new LIP, i.e., LIP1 in this case. The value 10 in the value field 1210 of the entry 1222 indicates that the 10 entries 1222-1240 all have the same local IP address LIP1. The value 10 is also referred to herein as the length of the list 1262.

The first two bits of the indicator 1202 of the entry 1224 are set to 00 indicating that the entry 1224 is a header entry with a new remote IP address, i.e., RIP1 in this case. The value 3 in the value field 1210 of the entry 1224 indicates that the 3 entries 1224-1228 all have the same LIP1 and RIP1. All bits of the indicator field 1202 of the entries 1226-1228 are set value 1. Accordingly, the entries 1226-1228 are data entries. In each data entry, the value field 1210 contains a cluster key derived from the LIP, RIP and RP of the data entry. For example, the key 1210 of the entry 1226 is a cluster key derived from LIP1, RIP1 and RP1. The entry 1230 starts a new RIP, i.e., RIP2 in this case. In the list 1274 starting from the entry 1230, there are five data entries 1232-1240. The list 1264 starts with the header entry 1242 with a new LIP, i.e., LIP2 in this case.

In one implementation, the list 1200 is an ordered high-speed hybrid indexing list sorted by LIP, RIP and then RP fields. The sorted hybrid indexing list 1200 allows fast search, such as binary search because each entry 1298 is of the same size. For example, when a query requests for data sent from a particular LIP to a particular RIP at a particular RP, the ordered hybrid indexing list 1200 supports an extremely fast search for determining the cluster key corresponding to the query. Each cluster node can also maintain additional ordered hybrid indexing lists. For example, an additional list is ordered by RIP, RP and then LIP. Furthermore, additional lists are not limited to a single three-level deep segmentation. The ordered hybrid indexing structure is equally efficient at one, two, or any N-deep configuration.

The hybrid indexing table 1200 includes a plurality of header entries with entry counts and a plurality of data entries with cluster keys. Furthermore, each data entry includes both data identifying communication devices and a cluster key. Header entries and data entries each incorporate an indicator 1202. The indicator specifies the type of the entry and the type of the header entry when the entry is a header entry.

The hybrid indexing table 1200 illustrates a hierarchical indexing structure. The hierarchical indexing structure 1200 illustrates a hierarchy with two levels indicated by the header entries 1222 and 1242, and the header entries 1224 and 1244. The hierarchical indexing structure 1200 can be a hierarchy of more than two levels. For instance, the third level can be indicated by header entries of different port numbers.

In a different implementation, the hierarchical indexing structure 1200 is used to record the usage data of mobile devices, such as cell phones. In such a case, the tier one header entries, such as the header entries 1222 and 1242, identify unique mobile devices by, for example, their Mobile Identification Number (“MIN”) or International Mobile Subscriber Identity (“IMSI”). The tier two header entries, such as the header entries 1224, 1230 and 1244, identify mobile device event types. The data entries include mobile usage data, such as phone calls, network access, application usage, etc.

In another implementation, the hierarchical indexing structure 1200 is used to record TV watching data. In such a case, the tier one header entries, such as the header entries 1222 and 1242, identify unique customer accounts by, for example, their account numbers. The tier two header entries, such as the header entries 1224, 1230 and 1244, identify TV set-top boxes. The data entries include TV watch data, such as watched channels and data and time, etc.

In yet another implementation, the hierarchical indexing structure 1200 is used to track and log system events of networked servers. In such a case, the tier one header entries, such as the header entries 1222 and 1242, identify unique server computers. The tier two header entries, such as the header entries 1224, 1230 and 1244, identify event categories. The tier three header entries identify event types. The data entries then include system event data, such as logins, etc.

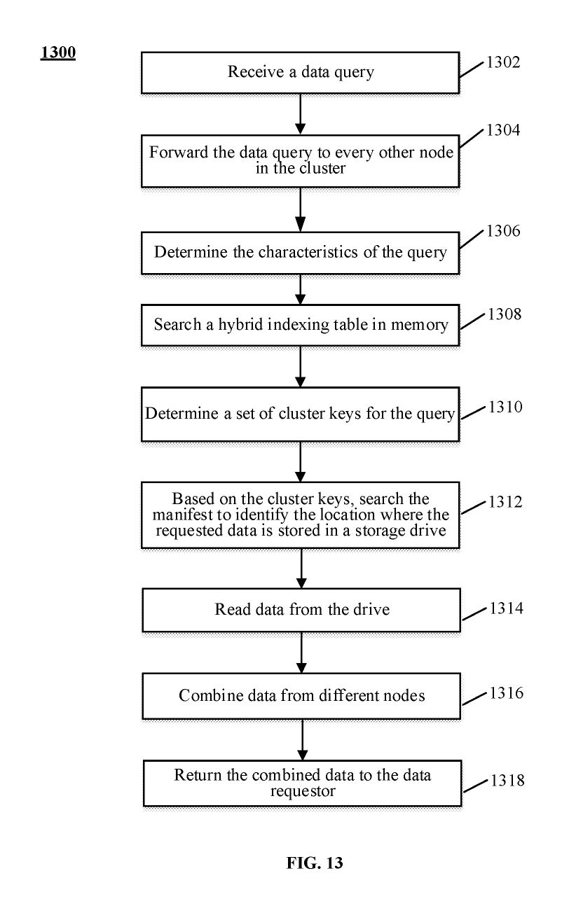

High speed data retrieval is further illustrated by reference to FIG. 13, in which a flowchart depicting the data retrieval using hybrid indexing lists is shown and generally indicated at 1300. At 1302, the cluster 1100 receives a data query for retrieving some amount of data. At 1304, the query coordinator 1102 distributes the query to all nodes within the cluster (such as the cluster 1100). At 1306, each node determines the characteristics (also referred to herein as attributes) of the query, such as a LIP, a RIP, a RP and time internal of the data requested. At 1308, the node searches a hybrid indexing table, such as the fast hybrid indexing list 1200 based on the characteristics of the query. The search is fast since the fast hybrid indexing list 1200 is sorted. At 1310, the node determines the set of cluster keys corresponding to the query. Each individual cluster key is stored in one entry of the hybrid indexing list 1200.

At 1312, based on the cluster keys and the time interval (indicated by a starting timestamp and an ending timestamp) the node searches a manifest, such as the manifest 700, to determine the location on a storage drive where the requested data is stored. It should be noted that a given cluster key may not exist in all nodes. When a cluster key is not present in the manifest of a particular node, the node then terminates the search for that key. When a cluster key is present in the manifest of a particular node, the node may not have data within the time interval of the query. In such a case, the node also terminates the query for that key and does not read a drive or returns any data. At 1314, the node reads the data from the drive. At 1316, the coordinator combines the read data from different nodes within the cluster. At 1318, the coordinator returns the combined data to the data requestor.

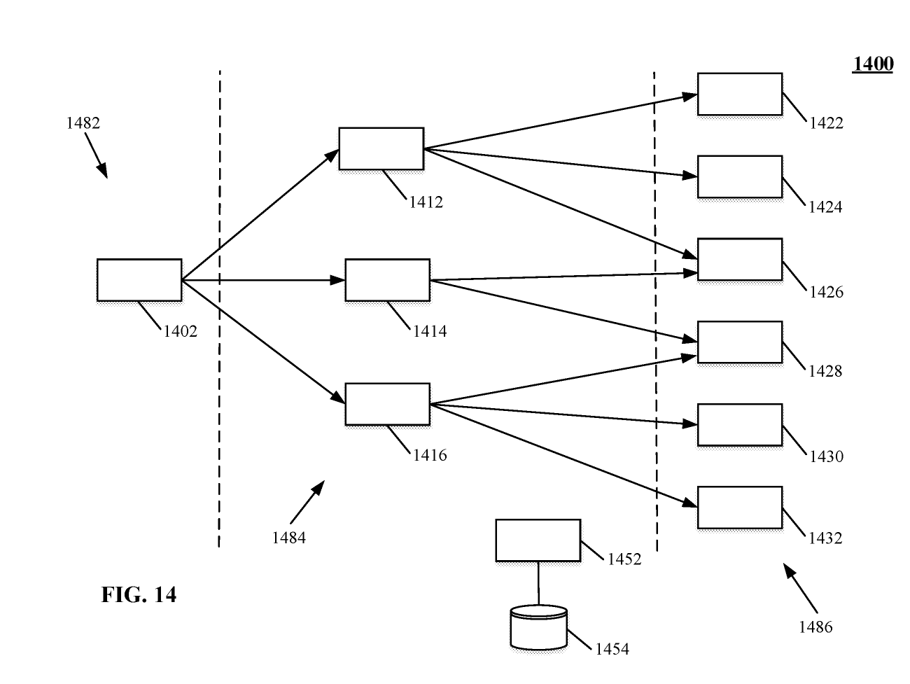

To maximize the data query processing performance of the massively parallel database management and be able to handle tens and even hundreds of millions of queries per second, the database system further incorporates a three tiered hierarchical architecture as shown in FIG. 14. Turning to FIG. 14, a simplified block diagram depicting the three layer hierarchical data query and fetched data processing architecture is shown and generally indicated at 1400. The three layers are indicated at 1482, 1484 and 1486 respectively. The dispatch tier 1482 of the hierarchical query processing system 1400 includes a dispatcher thread 1402; the search tier 1484 includes a set of search threads that run in parallel, such as search threads 1412, 1414 and 1416; and the aggregation tier 1486 include a set of aggregation threads that run in parallel, such as aggregation threads 1422-1432. The hierarchical query processing system 1400 further includes a storage drive access thread 1452 responsible for reading data from a storage drive 1454.

In one implementation, the threads 1402, 1412-1416 and 1422-1432 are pinned to a particular silo, such as the silo 102 or 104. In a further implementation, the thread 1452 is also pinned to the particular silo. The three tier hierarchical query processing system 1400 can thus be implemented in different sockets of each node within a cluster of the massively parallel database management system.

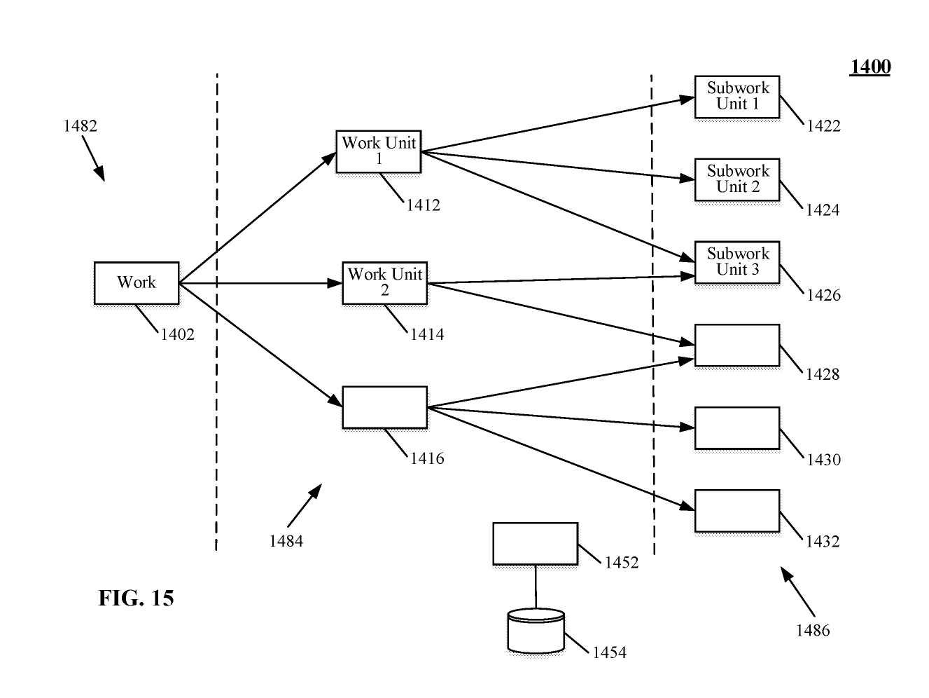

When a node receives a data query (such as that illustrated in FIG. 11), a silo of the node processes the data query and returns the requested data in accordance with the query. The data query handling is further illustrated by reference to FIG. 15. Referring now to FIG. 15, the dispatcher thread 1402 receives the data query (also referred to herein as a work). The dispatcher thread 1402 divide the work into one or more work units that are processed in parallel, such as two work units. A work unit is an independent portion of the work. The work units are then dispatched to different search threads in the search tier. For instance, the dispatcher thread 1402 divides a work into two work units to be processed by and associated with the search threads 1412-1414 respectively. In an alternate embodiment, the work unit is not divided into multiple work units. In such a case, it is said herein that the work unit is divided into one work unit.

As an example, the work is a data query for data sent from a local IP address to a remote IP address at a remote port from time T1 to T2. In one implementation, the dispatcher thread 1402 groups the set of cluster keys for the query, such as that determined at 1310, and associates the groups (i.e., subsets) of the set of cluster keys to different search threads. Each subset of cluster keys is a work unit. In one implementation, a work unit with more cluster keys is considered a bigger work unit.

In an alternate embodiment in accordance with the present teachings, the work unit 1 is a data query for data sent from the local IP address to the remote IP address at the remote port from time T1 to Tm; and the work unit 2 is a data query for data sent from the local IP address to the remote IP address at the remote port from time Tm to T2. In the example above, Tm is a timestamp between timestamp T1 and timestamp T2. When Tm is the middle point between T1 and T2, the work units 1 and 2 are regarded as work units of the same size by the dispatcher thread 1402. In other words, work units 1-2 are equal size work units. When Tm is closer to T2 than to T1, the work unit 1 is regarded as a bigger work unit by the dispatcher thread 1402 and the work unit 2 is regarded as a smaller work unit. When Tm is closer to T1 than to T2, the work unit 1 is regarded as a smaller work unit by the dispatcher thread 1402 and the work unit 2 is regarded as a bigger work unit.

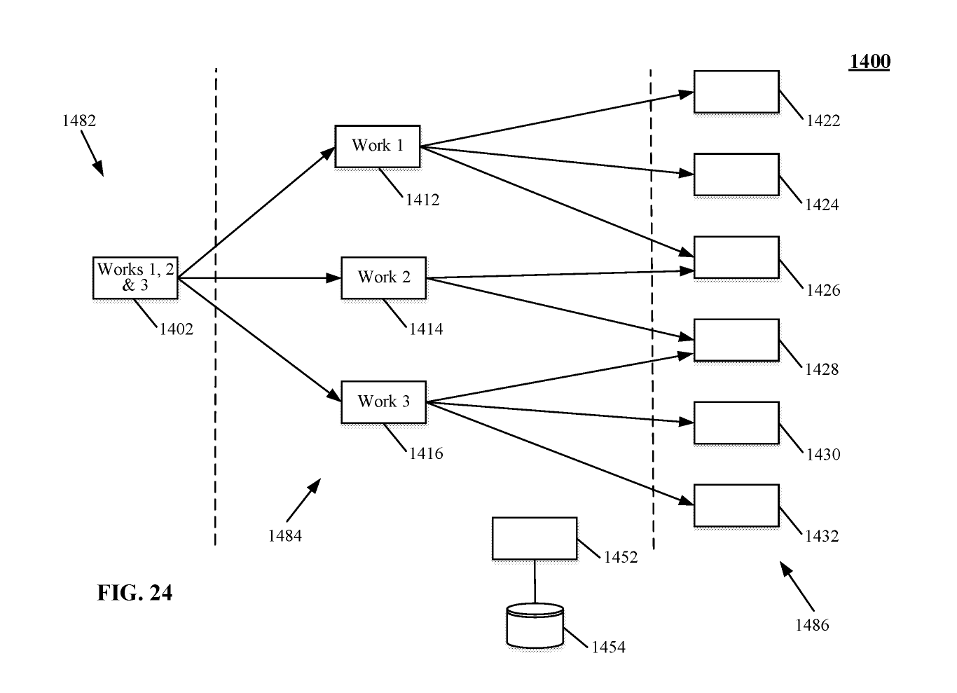

The search threads 1412-1414 process the work units 1-2 respectively. In one implementation, the search threads each divide a work unit into multiple subwork units that are processed in parallel. Each of the subwork units is an independent portion of the work unit. For example, the work unit is divided into the subwork units based on groups of cluster keys. For instance, each subwork unit corresponds to a group of cluster keys. As an additional example, the work unit 1 corresponds to the entire time period between T1 and Tm; and the subwork units correspond to different portions of time periods between T1 and Tm. The different portions of time periods are consecutive and not over lapping. Alternatively, a search thread does not divide a work unit into multiple subwork units. In such a case, it is also said herein that the search thread divides the work unit into one subwork unit. This alternate embodiment is further illustrated in FIG. 24.

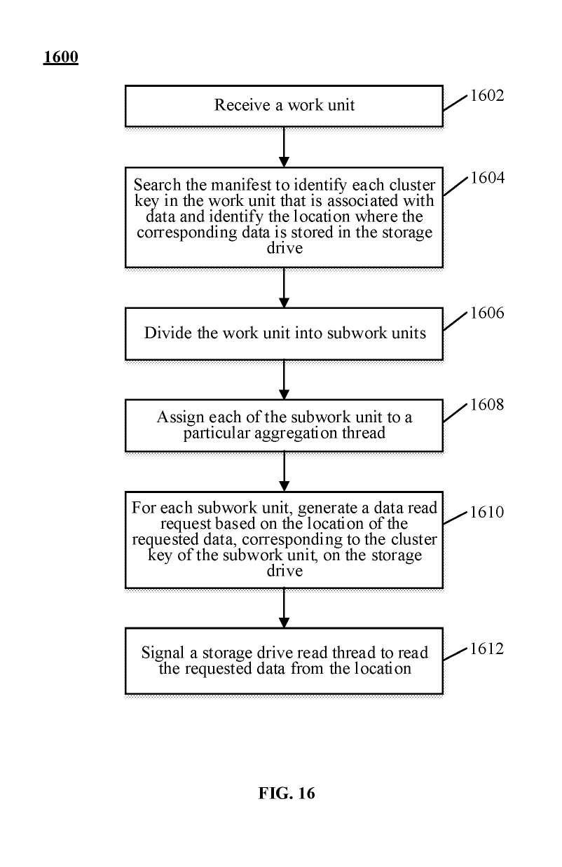

The processing of the work units 1-2 is further illustrated by reference to FIG. 16. Referring to FIG. 16, a flowchart depicting a process by which a search thread processes a work unit is shown and generally indicated at 1600. At 1602, the search thread receives a work unit (such as a data query). For instance, the search thread 1412 is notified of the work unit 1 for it to process via a notification event signaled by the dispatcher thread 1402. At 1605, the search thread searches a manifest (such as the manifest 700) to identify each cluster key that is present in the work unit and has data. The search thread further identifies the location on the storage drive where data corresponding to the cluster key is stored. At 1606, the search thread divides the work unit into one or more subwork units. For instance, each subwork unit includes one of the identified cluster keys that correspond to data on the storage drive 1454. In a further implementation, more than one cluster key is associated with to a subwork unit. At 1608, the search thread assigns each of the subwork units to an aggregation thread. In other words, the search thread associates each subwork unit with a particular aggregation thread.

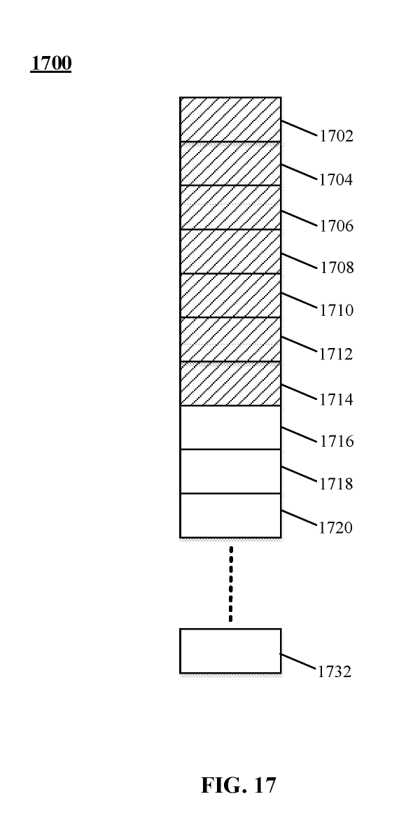

The search thread further maintains a list of buffers, which is further illustrated by reference to FIG. 17. Referring to FIG. 17, a block diagram of a buffer list maintained by a search thread is shown and generally indicated at 1700. The buffer list 1700 includes buffers 1702 through 1732, each of which is used to store an individual portion of data read from a storage disk. For instance, each buffer is used to store data of a subwork unit. Each individual buffer is considered to be in-use and unavailable for any additional storage tasks while it is actively being used by a search thread or aggregation thread.

Returning to FIG. 16, at 1610, for each subwork unit, the search thread generates a data read request based on the location determined at 1604. At 1612, the search thread signals the storage drive access thread 1452 to read the requested data of the subwork unit. For example, the search thread formulates a read request into the memory area of the buffer associated with the subwork unit, and notifies the thread 1452 via an event mechanism to process the data read request. In response, the storage drive read thread 1452 handles the request and other data read requests sent from other search threads. In such a case, the drive reading thread 1452 is highly utilized because multiple search threads operate in parallel to feed it with data read requests. Accordingly, the reading of the drive 1454 does not wait for data requests. The waiting occurs when, for example, there is only one search thread overly loaded with providing data read requests, or there are no additional requests to process.

In the tiered hierarchical system 1400, the drive 1454 is highly utilized for providing data with least amount of idling time. Furthermore, since multiple search threads are all submitting data read requests in a silo, the drive 1454 is made to process a large number of parallel requests. Different from conventional database management systems, the highly parallel nature of the new paradigm reduces the total time required to process a given query because it is divided into a large number of parallel tasks to be executed at once, instead of in sequence.

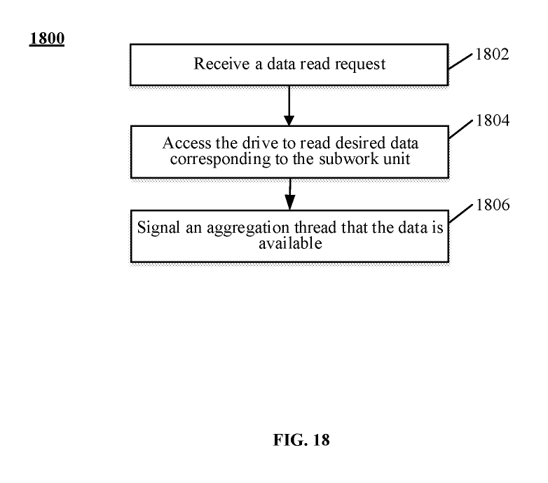

The process by which the storage drive 1452 provides data is further illustrated by reference to FIG. 18. Turning to FIG. 18, a flowchart depicting a process by which a storage drive reading thread handles data read requests is shown and generally indicated at 1800. At 1802, the drive reading thread receives a data read request, such as that sent at 1616. At 1804, the drive reading thread accesses the drive 1454 to read data as required by the data request. At 1806, the drive reading thread signals the aggregation thread that the requested data is available. For example, the data request identifies the aggregation thread. The subwork unit is associated with the aggregation thread by the search thread.

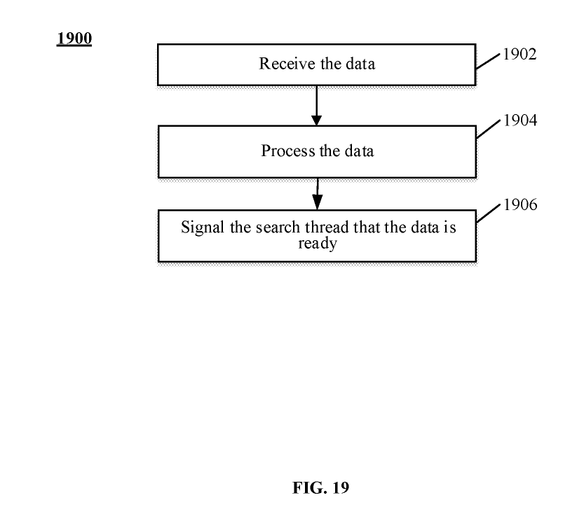

The process by which the aggregation thread processes the data read by the drive access thread 1452 is shown and generally indicated at 1900 in FIG. 19. Referring to FIG. 19, at 1902, the aggregation thread receives the data. For example, the aggregation thread is notified by the drive access thread 1452 when the data is ready and then access the data. In such a case, it is said the aggregation thread receives the data. The data is stored in the buffer entry storing the subwork unit. Alternatively, the data is stored in a different memory area. At 1904, the aggregation thread processes the data. For example, the aggregation thread converts the data into a particular format. As an additional example, the aggregation thread conducts statistical analysis on the data. As still a further example, the aggregation thread searches the data for particular information. At 1906, the aggregation thread signals the search thread that the data is ready.

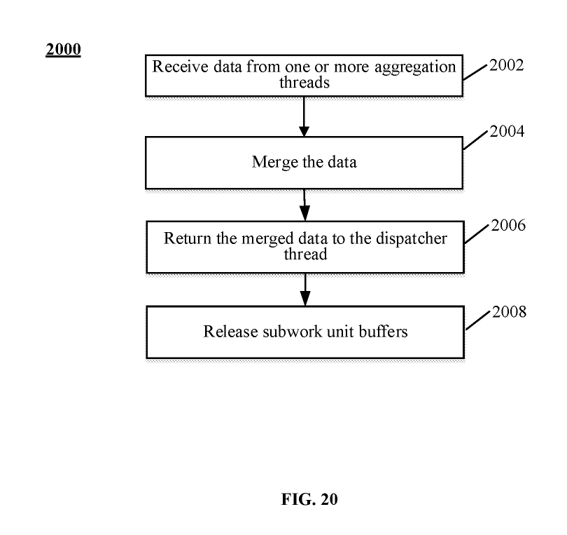

Turning to FIG. 20, a flowchart depicting a process by which a search thread receives data from aggregation threads, merge the data and return the merged data is shown and generally indicated at 2000. At 2002, the search thread receives data from one or more aggregation threads (such as the threads 1422-1426). For instance, the search thread 1412 receives data corresponding to the subwork units 1-3 from the aggregation threads 1422-1426 respectively. As used herein, a search thread is said to receive data from an aggregation thread when the aggregation thread signals the search thread that the data is available. At 2004, the search thread merges the data corresponding to work unit 1. At 2006, the search thread returns the merged data to the dispatcher thread by signaling the dispatcher thread that the data for work unit 1 is available. At 2008, the search thread releases the usage of buffers of the subwork units 1-3. In other words, these three buffers can be used for new subwork units.

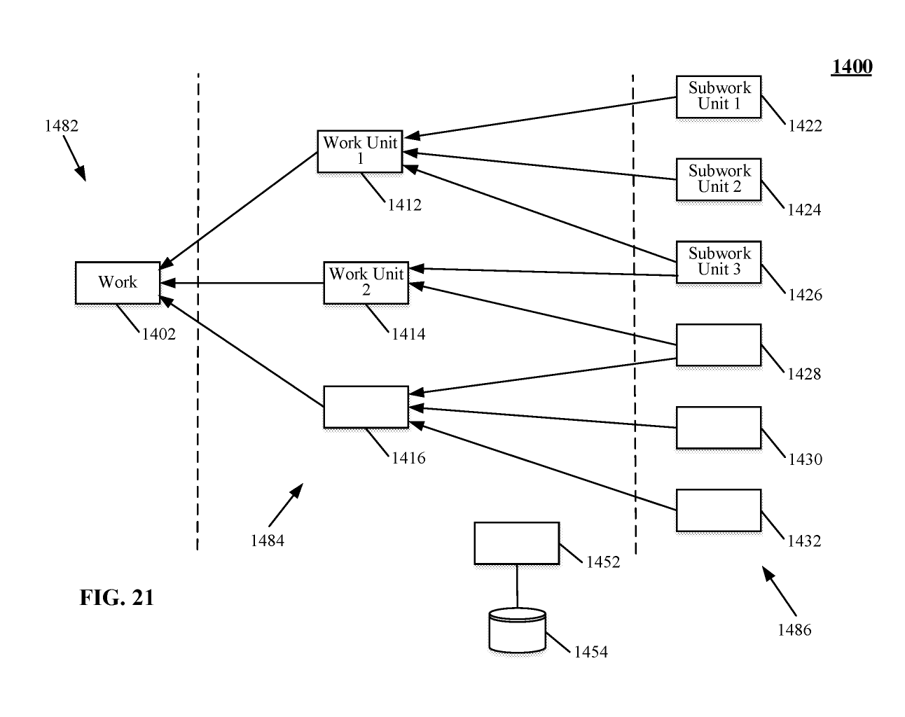

The dispatcher thread 1402 then merges data of all work units of a particular work to produce a final result. For example, it merges data for the work units 1-2 from the search threads 1412-1414. Thereafter, the dispatcher thread 1402 returns the merged data (i.e., data requested by the work) to a requester, such as another computer within the database management system, a web server or a computer of a third party or a different system. The data flow from aggregation threads to search threads and then to the dispatcher thread are indicated in FIG. 21.

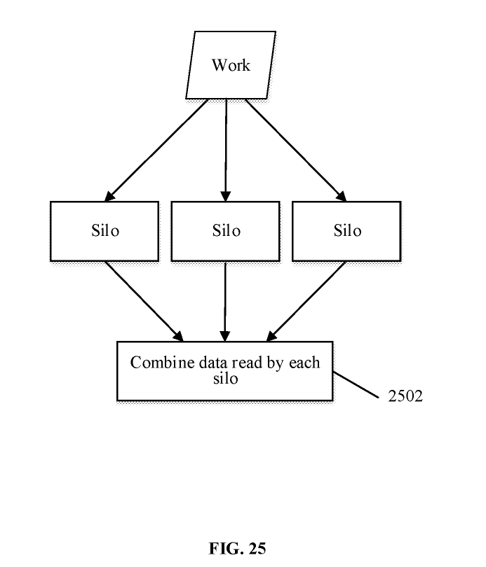

In one implementation, a work is concurrently processed by more than one silo within a node as shown in FIG. 25. Each silo implements the hierarchical data processing architecture 1400. After each silo returns the data that it reads from a storage drive, all the data is then combined at 2502 and returned to the coordinator 1102. The coordinator 1102 then combines data from different nodes and returns the combined data to the data requestor.

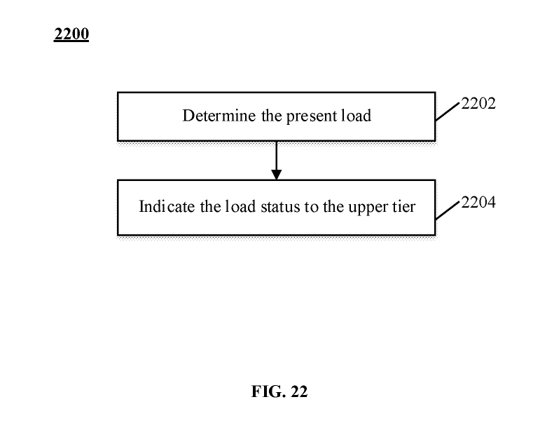

Different work units oftentimes require different amount of resources, such as computer processing time of a core, and it is not always known in advance the amount of resources that will be necessary. Accordingly, some search threads may have a higher load than others at particular points in time. It is thus desired for search threads to provide backward pressure to the dispatcher thread, i.e., from the tier 2 to the tier 1. More generally speaking, a lower stream tier (or thread) provides backward pressure to an upper stream tier (or thread). The backward pressure communication is further illustrated by reference to FIG. 22.

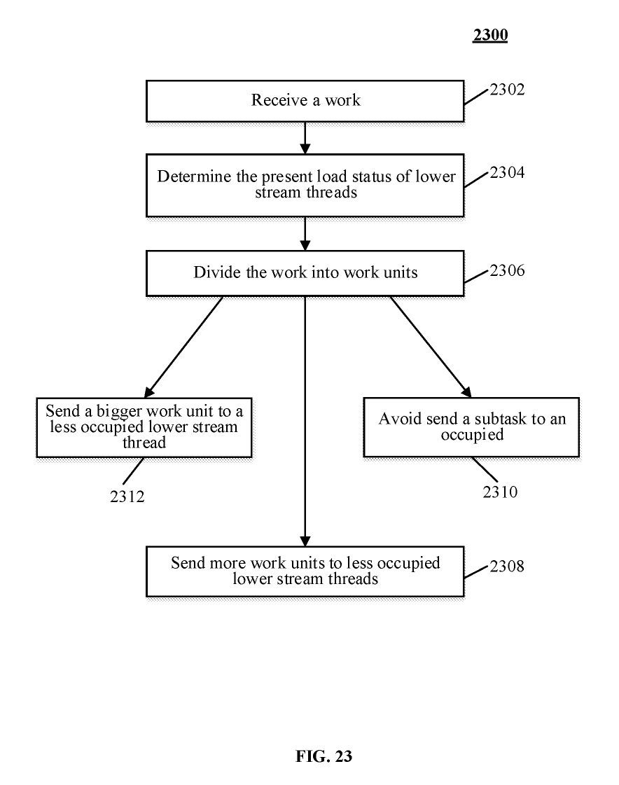

Referring to FIG. 22, a flowchart depicting a process by which a search thread provides backward pressure to the tier 1482 is shown and indicated at 2200. At 2202, the search thread determines its current load. For example, it derives a load based on the percentage of buffers that are being in use. For instance, when its buffers 1702-1714 are in use and there are twenty buffers in total, the load (also referred to herein as backward pressure) is thirty five percent (35%). At 2204, the search thread indicates the load status to the dispatcher thread 1402 by, for example, a message or a notification event. In response, the upper tier distributes more tasks to less utilized search threads. The backward pressure communication mechanism helps avoid hot spot in the three layered hierarchical parallel system 1400. The task allocation by the tier 1482 is further illustrated by reference to FIG. 23.

Referring to FIG. 23, a flowchart depicting a process by which an upper tier allocates tasks based on backward pressure is shown and indicated at 2300. At 2302, the dispatcher thread 1402 receives a work (such as a data query). At 2304, the dispatcher thread 1402 determines the backward pressure of lower stream threads, such as the search threads 1412-1416. At 2306, the dispatcher thread 1402 divides the work into work units. For instance, the dispatcher thread 1402 groups cluster keys within the set of cluster keys determined at 1310 by dividing the set of cluster keys into different subsets. Each subset of cluster keys corresponds to a work unit.

At 2308, the dispatcher thread 1402 sends more work units to less occupied search threads, and fewer or none work units to more occupied search threads. For example, the allocation of work units between search threads are based on thresholds. When a search thread's load is over a threshold, it then receives no work units (as shown at 2310) until its load falls below the threshold. As an additional example, a search thread with a load of ten percent receives two work units while another search thread with a load of fifty percent receives one work unit when there are three work units available for processing. In a different implementation, at 2312, theg dispatcher thread 1402 sends bigger work units to less occupied search threads and smaller work units to more occupied search threads.

Obviously, many additional modifications and variations of the present disclosure are possible in light of the above teachings. Thus, it is to be understood that, within the scope of the appended claims, the disclosure may be practiced otherwise than is specifically described above. For example, the aggregation threads communicate backward pressure to the search threads.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A cluster node within a database management system, the cluster node comprising:
i) a processing unit, a storage disk drive accessible by said processing unit, and a networking interface operatively coupled to said processing unit;
ii) a set of first tier threads running on said processing unit;
iii) a set of second tier threads running on said processing unit; and
iv) wherein a first tier thread within said set of first tier threads is adapted to:
1) receive a task for retrieving data stored on said storage disk drive;
2) divide said task into a set of subtasks; and
3) assign said set of subtasks between a subset of second tier threads within said set of second tier threads.

2. The cluster node of claim 1 wherein said task is a work and each subtask within said set of subtasks is a work unit.

3. The cluster node of claim 2 wherein each work unit within said set of work units corresponds to a group of cluster keys, wherein each cluster key within said group of cluster keys corresponds to a specific location on said storage disk drive storing data corresponding to said work.

4. The cluster node of claim 2 wherein each work unit within said set of work units corresponds to a portion of a time segment, wherein said time segment indicates a range of data requested by said work.

5. The cluster node of claim 1 wherein said task is a work unit and each subtask within said set of subtasks is a subwork unit.

6. The cluster node of claim 1 wherein said set of subtasks are processed by said subset of second tier threads in parallel.
